(19) United States
(12) Patent Application Publication
(10) Pub. No.: US 2022/0230181 A1
(43) Pub. Date: Jul. 21, 2022

(54) NEXT BEST ACTION FRAMEWORK WITH NESTED DECISION TREES

(71) Applicant: ServiceNow, Inc., Santa Clara, CA (US)

(72) Inventors: Sanjay Gupta, Saratoga, CA (US); Ankur Jain, Hyderabad (IN); Rahul Guha, Milpitas, CA (US); Rajesh Kannan Gurusamy, Hyderabad (IN); Prashant Dindure, Hyderabad (IN); Elizabeth Ilona Szeles, San Jose, CA (US); Mahesh Bhandarkar, Mountain View, CA (US); Shilpa Shree Rajashekara, Sunnyvale, CA (US); Utkarsh Rawat, Mumbai (IN); Abishek Vanam, Hyderabad (IN); Amanda Nichole Chaffee, Fremont, CA (US)

(21) Appl. No.: 17/154,823

(22) Filed: Jan. 21, 2021

(51) Int. Cl. G06Q 30/00; G06N 5/00; G06N 20/00

(52) U.S. Cl. CPC G06Q 30/016; G06N 20/00; G06N 5/003

(57) ABSTRACT

A system includes one or more client instances of a client hosted by a platform, in which the one or more client instances include an agent portal. The agent portal may receive a request from a customer related to a customer issue, determine a context for the customer issue based on one or more attributes, and determine a subset of actions as recommended actions based on factors to resolve the customer issue. The factors may include the context, historical data associated with the customer, and/or a client interest associated with the client. Moreover, the agent portal may rank the recommended actions as ranked recommended actions, display the ranked recommended actions for selection by the agent, and provide a guidance corresponding to a selected recommended action.

### BACKGROUND

The present disclosure relates generally to generating and ranking recommended actions to complete a task, as well as using information utilized and/or generated during execution of a selected recommended action for a related recommended action.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Enterprise networks, systems, and other related processes may utilize software and hardware resources, often implemented on multiple, inter-connected devices, to conduct activities or otherwise perform the activities of various enterprise operations. In some situations, provisioning, configuring, expanding, maintaining, and/or normal use of such resources, as well as related systems, may give rise to an agent of the enterprise being tasked with completing one or more tasks. In other instances, a client of the enterprise may communicate with the agent and request a resolution for an issue, or the client may provide products and/or services to customers of the client who may in turn request a resolution of an issue related to the products and/or service. In such instances, a client agent may receive various recommended actions to guide the client agent to complete the one or more tasks. However, determining the recommended actions and/or hierarchy of the recommended actions, in view of particular conditions, for example, a focus or interest associated with the business or organization of the client, may be difficult.

Moreover, as the client agent performs the recommended action, an outcome during execution of the recommended action or upon completion of the recommend action, may be associated with a related recommended action. That is, the outcome of the recommended action includes information relevant to the related recommended action or triggers the related recommended action. Thus, the related recommend action may utilize at least some of the information generated from the agent executing processes for the recommended action. However, communicating the information between the presently executed recommended action and the related recommended action may be difficult.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The systems and methods described herein provide an agent one or more recommended actions (e.g., next best actions or optimal actions) of possible actions for performing a task, such as providing a resolution to a customer. In particular, the systems and methods may determine the best recommended actions based on context-specific conditions. The conditions may include context attributes (e.g., information related to a case or a customer), calculated attributes (e.g., derived attributes from the context attributes), a history of actions of the customer, and/or business interest or focus area for the client (e.g., customer satisfaction). After determining the best recommended actions from among a set of possible actions, the system and methods may rank the recommended actions (e.g., best recommended action (e.g., next best action), second most recommended action (e.g., second best action), third most recommended action (e.g., third best action), and so forth). The ranking may be based on one or more factors and/or weights associated with the one or more factors. For example, the ranking may be based on an overall score calculated by a sum of the products of the one or more factors and associated weights, in which the highest score corresponds to the best recommended action (e.g., most recommended action). In some embodiments, the one or more factors may include the interest or focus area for the client (e.g., interest area for a bank client of the enterprise), a likelihood of the customer acting in accordance to the interest or focus area, a resulting profit for the client, and so forth. For ranking based on the factor of the customer acting in accordance to the interest, the systems and methods described herein may determine a likelihood based at least in part on past data related to the customer (e.g., history of actions for the customer).

The systems and methods described herein also link or communicate outcomes (e.g., outputs) determined and/or information utilized during the guidance for a presently executed recommend action (e.g., steps performed to complete the recommend action) to related recommended actions. For example, the outcome at a decision node of a decision tree providing guidance for the presently executed recommended action may be applicable to a related recommended action. That is, the related recommendation may benefit from automatically receiving information associated with the outcome rather than having the agent perform the same or similar steps to gain the same information. Thus, by transmitting this information from the decision tree of the presently executed recommended action to the decision tree of a related recommended action, the agent may avoid reentering at least some of the information entered when implementing the recommended action.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a flow diagram for generating and ranking recommended actions, in accordance with aspects of the present disclosure;

FIG. 6 is a process flow diagram for providing and updating the recommended actions, in accordance with aspects of the present disclosure;

FIG. 7 is an example illustration of a user interface illustrating an indication of a new recommended action based on customer activity, in accordance with aspects of the present disclosure;

FIG. 8 is an example illustration of a user interface illustrating a guided decision tree corresponding to a presently executed recommended action, in accordance with aspects of the present disclosure;

FIG. 9 is an example illustration of a user interface illustrating execution of the guided decision tree corresponding to the recommended action and an indication of a new recommended decision tree corresponding to the new recommended action, in accordance with aspects of the present disclosure;

FIG. 10 is an example illustration of a user interface illustrating execution of the new recommended decision tree, in accordance with aspects of the present disclosure;

FIG. 11 is an example illustration of a user interface illustrating a first question at a first node of a decision tree for a presently executed recommended action, in accordance with aspects of the present disclosure;

FIG. 12 is an example illustration of a user interface illustrating a second question as a second node of the decision tree based on an outcome of the first question, in accordance with aspects of the present disclosure;

FIG. 13 is an example illustration of a user interface illustrating a completed execution of the recommended action, in accordance with aspects of the present disclosure;

FIG. 14 is a flow diagram illustrating linking decision trees corresponding to recommended actions, in accordance with aspects of the present disclosure;

FIG. 15 is a process flow diagram for an authoring process for the guided decision trees corresponding to best recommended actions, in accordance with aspects of the present disclosure;

FIG. 16 is a process flow diagram for a guidance process to guide an agent for a selected best recommended action, in accordance with aspects of the present disclosure;

FIG. 17 is an example illustration of a user interface illustrating generation of a case based on the customer request, in accordance with aspects of the present disclosure;

FIG. 18 is an example illustration of a user interface illustrating a view of pending cases, in accordance with aspects of the present disclosure;

FIG. 19 is an example illustration of a user interface illustrating guidance details for a selected case, in accordance with aspects of the present disclosure;

FIG. 20 is an example illustration of a user interface illustrating a guided execution for the recommended action for the selected case, in accordance with aspects of the present disclosure;

FIG. 21 is an example illustration of a user interface illustrating an additional guidance execution, in accordance with aspects of the present disclosure;

FIG. 22 is an example illustration of a user interface providing further additional guidance, in accordance with aspects of the present disclosure;

FIG. 23 is an example illustration of a user interface illustrating a completed guidance for nested decision trees for related recommended actions, in accordance with aspects of the present disclosure; and

FIG. 24 is an example illustration of a user interface illustrating the additional guidance execution with different or new input from the customer, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, an “agent” refers to an administrative agent (e.g., a support or service agent) and/or to a computer generated intelligent virtual agent. Also, as used herein, “best actions” or “best recommended actions” refers to most applicable or most relatively relevant actions of possible actions. By way of example, one or more actions may be the best recommended actions (e.g., top three actions) of multiple possible or available actions based on one or more conditions, such as client interest, profitability for the client, etc. Moreover, as used herein, a “guidance” refers to a guide for an automatic or manual action to be performed based on one or more decision nodes of one or more decision trees associated with a selected recommended action. Specifically, the guidance may involve guiding the agent through the one or more decision nodes of the one or more decision trees associated with the recommended action. By way of example, the agent performing the recommended action may be guided to step through the one or more decision trees and/or one or more decision nodes. The outcome or result (e.g., output) of completing of one or more decision trees and/or one or more decision nodes may be used as information for decision nodes of the one or more decision trees for related recommended actions. In some instances, the outcome of the presently executed recommended action may cause, trigger, or otherwise initiate additional or subsequent guidance for the same or a different decision tree that utilizes the information. Additionally, as used herein, a “related recommended action” refers to an action associated with the presently executed recommended action, the outcome at the one or more decision trees and/or decision nodes of the presently selected recommended action, and/or an action otherwise related to interests of the client. The related recommended action may be associated with one or more decision trees (e.g., separate and/or different decision trees) and/or one or more decision nodes, and further, may be associated with additional related recommended actions and their respective one or more decision nodes and/or one or more decision trees.

Also, as used herein, a “context” refers to a record for which information is collected, such as pertaining to the customer, the client, the client agent, and so forth. The context may include information, such as an incident, interaction, or the like, that the client presents to the agent in a client portal. That is, the context may refer to the record authored by an administrator (e.g., administrative agent of the client) for which information is collected, such as information for the customer requesting a resolution, the client agent, technical information related to a customer request, and so forth. By way of example, if a customer requests a resolution for an issue related to a network event or issue submitted by the client, the context may include information related to the network, devices attempting to connect to the network, information about these devices, the customer's present network package, and so forth. In some instances, the context may include information collected from the agent and/or the customer at a node of a decision tree associated with one or more recommended actions.

As discussed herein, a customer may send a request to a client agent for a solution to one or more services or products provided by the client. The client agent may receive multiple recommended actions that may be performed to resolve the request. However, determining the best recommended actions and/or hierarchy of the recommended actions, in view of particular conditions, may be difficult. By way of example, the conditions may be based on an interest associated with the business of the client and/or probability that the customer will act upon the recommended action.

Often, the selected recommended action of the best recommended actions may be associated with other recommended actions, such as additional processes associated with resolving the request. That is, implementing the recommended action may relate to or trigger the agent to perform additional recommended actions. Moreover, the agent may enter at least some of the same information for a presently executed recommended action and the additional recommended actions. By way of example, the agent may perform one or more steps for the recommended action and based on the outcome at a particular step, the agent may be prompted to perform the additional recommended actions.

Accordingly, it is now appreciated that there is a need to provide a narrowly tailored subset of recommended actions as best recommended actions, including the most applicable recommended actions, in view of the context. That is, based on certain conditions (e.g., probability of success related to the customer, business interest, etc.), the most applicable recommended actions may be provided to the agent to quickly and efficiently resolve the customer request. The best recommended actions may also be ranked in a hierarchy based on these conditions to provide the agent a view of the most applicable to less applicable recommended actions of the best recommended actions. Additionally, there is also a need to efficiently manage and resolve multiple recommended actions for a task (e.g., the resolution to the customer request), so as to reduce or eliminate the time used to input redundant information or perform redundant processes for the related recommended actions.

Although the following discussions describe recommended actions and decision trees used to guide an agent of a client to resolve a customer request, the systems and methods used herein may apply to other users (e.g., different agents within different departments for the client, the customer, etc.) that may benefit from recommended actions. For example, the customer, rather than the agent, may receive the recommended actions directly. Moreover, although the following discussions describe the recommended actions and decision trees with respect to a business client, such as a bank, the systems and methods described herein may also apply to other non-business related contexts, such as education, training, and so forth. In such environments, the recommended actions may correspond to the interest for the education or training entities.

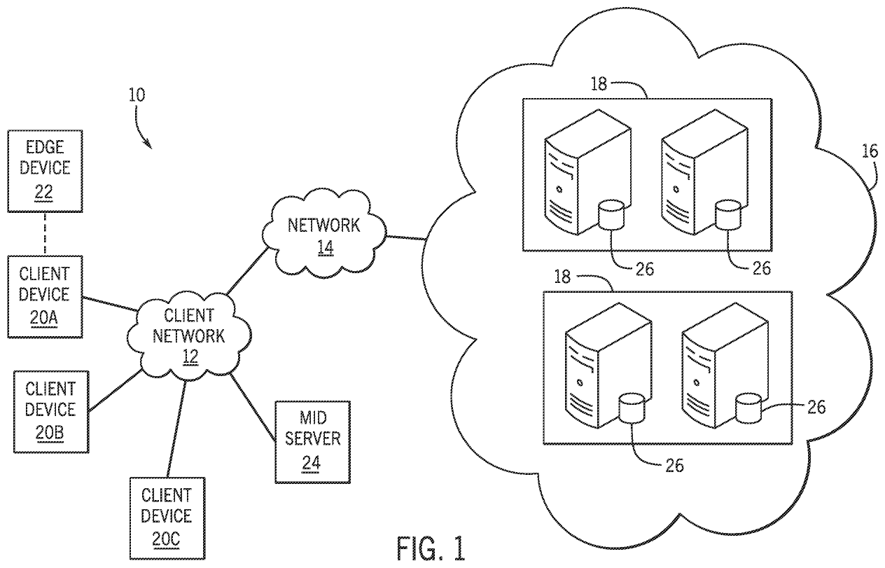

With the preceding in mind, the following figures relate to various types of generalized system architectures or configurations that may be employed to provide services to an organization in a cloud-computing framework and on which the present approaches may be employed. Correspondingly, these system and platform examples may also relate to systems and platforms on which providing simultaneous or streamlined resolutions customer issues or problems, as discussed herein, may be implemented or otherwise utilized. Turning now to FIG. 1, a schematic diagram of an embodiment of a cloud computing system 10, where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that may include one or more LANs, virtual networks, data centers 18, and/or other remote networks.

As shown in FIG. 1, the client network 12 is able to connect to one or more client devices 20A, 20B, and 20C so that the client devices 20 are able to communicate with each other and/or with the network hosting the platform 16. The client devices 20 may be computing systems and/or other types of computing devices generally referred to as Internet of Things (IoT) devices that access cloud computing services, for example, via a web browser application, a portal, or via an edge device 22 that may act as a gateway between the client devices 20 and the platform 16. In some implementations, client devices 20 using a portal to access the cloud computing services may be used to send a request to an agent via the portal. The request may cause the agent to request and receive the best recommended actions to resolve the request.

FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

As depicted, the client network 12 may be coupled to a network 14. The network 14 may include one or more computing networks, such as other LANs, wide area networks (WAN), the Internet, and/or other remote networks, to transfer data between the client devices 20 and the network hosting the platform 16. For example, the platform 16 (e.g., management system of the platform 16) may receive, store, and retrieve data related to the client and/or the client's customers as context for determining the best recommended actions and/or hierarchy of the recommended actions (e.g., the best recommended action, the second best recommended action, and so forth). In some embodiments, the platform 16 may receive additional information related to the client or client's customers while the agent is performing a recommended action and based on the additional information, the platform 16 may determine a different action may be one of the best recommended actions and recommend it as such.

Each of the computing networks or infrastructures discussed herein may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. For example, the networks may also employ any number of network communication protocols, such as Transmission Control Protocol (TCP) and Internet Protocol (IP). Although not explicitly shown in FIG. 1, the networks and infrastructures shown may include a variety of network devices, such as servers, routers, network switches, and/or other network hardware devices configured to transport data.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprises, IT, and/or other organization-related functions. In one embodiment, the network hosting the platform 16 is implemented on the one or more data centers 18, where each data center may correspond to a different geographic location. Each of the data centers 18 includes a plurality of virtual servers 26 (also referred to herein as application nodes, application servers, virtual server instances, application instances, or application server instances), where each virtual server 26 may be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server 26 instances handles requests from and serves multiple customers. Data centers 18 with multi-tenant cloud architecture commingle and store data from multiple customers, where multiple customer instances are assigned to one of the virtual servers 26.

In a multi-tenant cloud architecture, the particular virtual server 26 distinguishes between and segregates data and other information of the various customers. For example, a multi-tenant cloud architecture may assign a particular customer identifier (ID) for each client (e.g., organization) in order to identify and segregate the data from each client. Generally, implementing a multi-tenant cloud architecture may suffer from various drawbacks, such as a failure of a particular one of the server 26 instances causing outages for all clients allocated to the particular server instance.

In another embodiment, one or more of the data centers 18 are configured using a multi-instance cloud architecture to provide every client its own unique client instance or instances. For example, a multi-instance cloud architecture may provide each client instance with its own dedicated application server and dedicated database server. In other examples, the multi-instance cloud architecture may deploy a single physical or virtual server 26 and/or other combinations of physical and/or virtual servers 26, such as one or more dedicated web servers, one or more dedicated application servers, and one or more database servers, for each client instance.

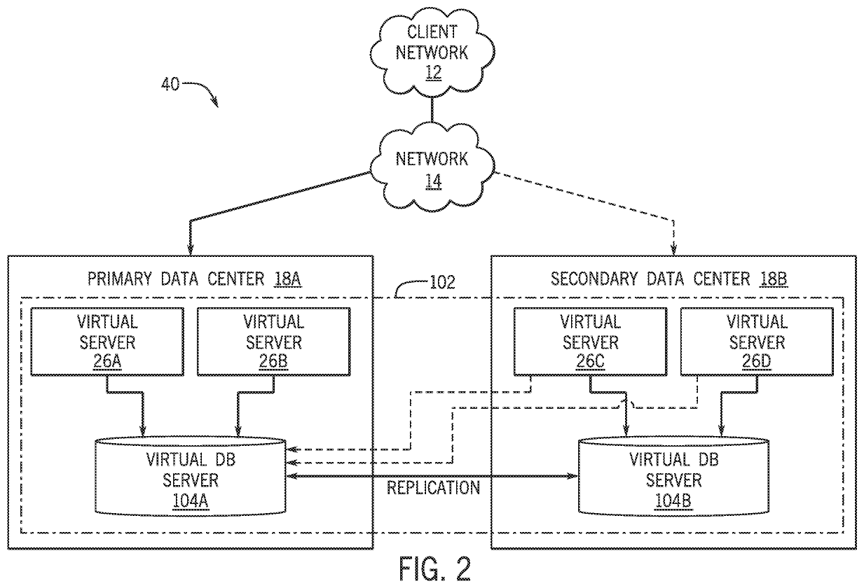

In a multi-instance cloud architecture, multiple client instances may be installed on one or more respective hardware servers, where each client instance is allocated certain portions of the physical server resources, such as computing memory, storage, and processing power. By doing so, each client instance has its own unique software stack that provides the benefit of data isolation, relatively less downtime for clients to access the platform 16, and client-driven upgrade schedules. An example of implementing a client instance within a multi-instance cloud architecture will be discussed in more detail below with reference to FIG. 2.

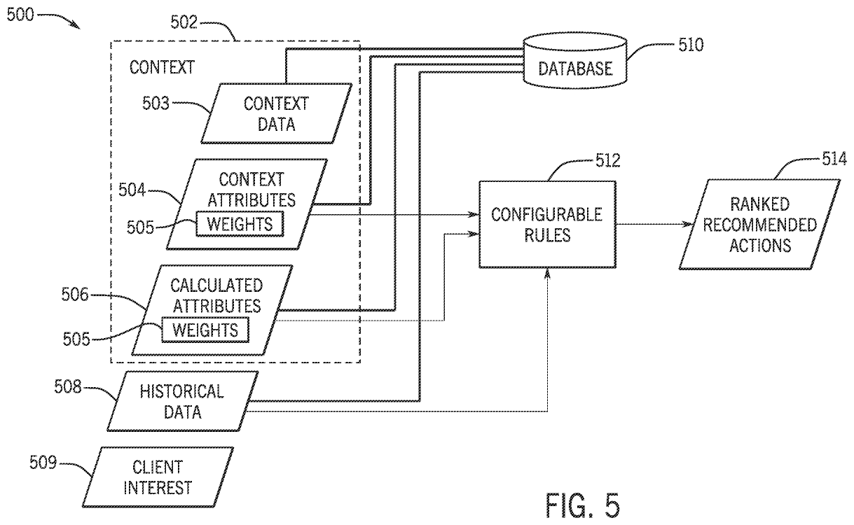

As discussed herein, the client instance may be associated with an organization or business that provides a product and/or business to one or more customers. As part of enhancing customer experience of a computer environment, such as those described above, an agent of the client (e.g., agent) may perform recommended actions to complete tasks, such as those related to customer requests and/or to maintain the client network 12. For example, the agent may receive best recommended actions for completing the tasks. The tasks may be related to maintaining the computer environment, updating resources of the computer environment, resolving an issue for the customer through a recommended action (e.g., received through a client portal), and other business related tasks. As will be discussed with respect to in FIGS. 5-13, the agent may receive recommended actions in a hierarchy and the recommended actions may be dynamically updated, for example, while the agent is interfacing with the customer. Specifically, the system may receive new and different data related to the customer, such that a previous hierarchy of the best recommended actions may no longer be applicable or may need reordering. In additional or alternative embodiments, an outcome (e.g., an output) at a decision node of a decision tree of the presently implemented recommended action (e.g., selected one of the best recommended actions) or upon completion of the decision tree, may be applied to related recommended actions. For example, an outcome (e.g., test status code, description of a service or product, particular software installation, etc.) of a guidance action performed at a particular decision node of the decision tree of the presently executed recommended action (e.g., sub-action of the recommended action) may trigger guidance for the agent to a different decision tree corresponding to a recommend action related to the presently executed recommended action.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers 104 (e.g., virtual database servers 104A and 104B). Stated another way, the virtual servers 26A-26D and virtual database servers 104A and 104B are not shared with other client instances and are specific to the respective client instance 102.

In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 40 may include other types of dedicated virtual servers, such as a web server. For example, the client instance 102 may be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 40, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and may utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

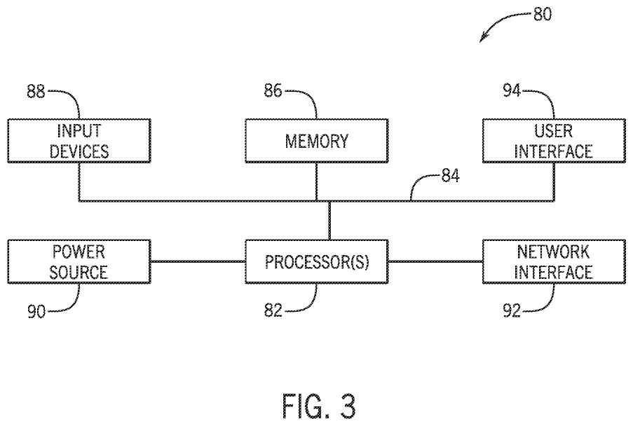

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 80 and their potential interconnections or communication paths, such as along one or more busses. As illustrated, the computing system 80 may include various hardware components such as, but not limited to, one or more processors 82, one or more busses 84, memory 86, input devices 88, a power source 90, a network interface 92, a user interface 94, and/or other computer components useful in performing the functions described herein.

The one or more processors 82 may include one or more microprocessors capable of performing instructions stored in the memory 86. For example, instructions may include instructions for generating the recommended actions, a hierarchy of the recommended actions, and/or dynamically updating the recommended actions and/or the best recommended action. The instructions may also include instructions for automatically generating and/or applying one or more outcomes of the presently executed recommended action to a related recommended action. Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 include suitable electrical channels to provide data and/or power between the various components of the computing system 80. The memory 86 may include any tangible, non-transitory, and computer-readable storage media. Although shown as a single block in FIG. 1, the memory 86 may be implemented using multiple physical units of the same or different types in one or more physical locations. The input devices 88 correspond to structures to input data and/or commands to the one or more processors 82. For example, the input devices 88 may include a mouse, touchpad, touchscreen, keyboard and the like.

The power source 90 may be any suitable source for power of the various components of the computing system 80, such as line power and/or a battery source. The network interface 92 may include one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

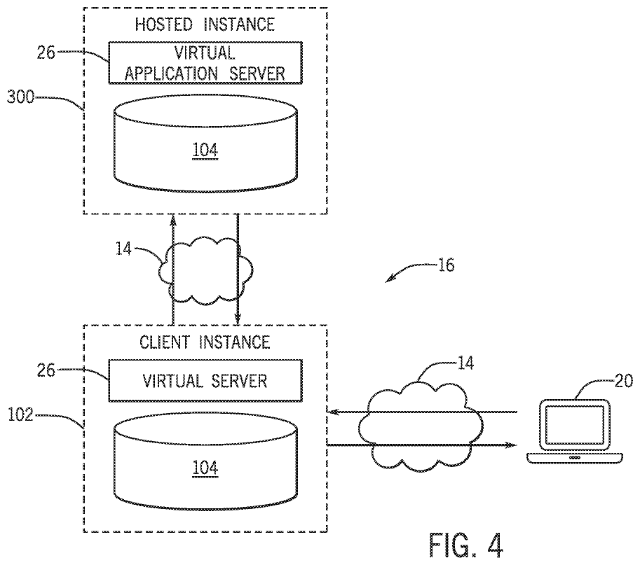

With the preceding in mind, FIG. 4 is a block diagram illustrating an embodiment in which a hosted instance 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a portal on the client device 20D), that may further provide an interface with the customer (e.g., client agent interfacing with customer through online chat). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As such, single or multiple client instances 102 or the hosted instance 300 may provide a system for efficiently managing recommended actions, as described herein.

FIG. 5 is a flow diagram 500 for generating and ranking best recommended actions for an agent to implement, such as to resolve a customer issue or problem. Although the following descriptions describe the systems and methods to determine the best recommended actions (e.g., next best action framework) corresponding to decision trees, which represents a particular embodiment, the recommended actions may also apply to the sub-trees and/or separate and distinct additional decision trees for the related recommended actions. For example, the agent may select one of the best recommended actions to resolve a customer request that corresponds to a particular decision tree. The agent may implement a guidance or action at a first node of the decision tree and based on the output at the node, the system may generate a subsequent set of best recommended actions for the agent for a second node of the decision tree and/or for a related recommended action based on a different decision tree.

In general, generating a set of best recommended actions (e.g., next best actions) and ranking them as ranked recommended actions 514 (e.g., ranked best recommended actions), may include a context 502, which includes context data 503, context attributes 504, and calculated attributes 506. Generating the ranked recommended actions 514 may also involve using historical data 508, client interest 509, and configurable rules 512. That is, generating and ranking the best recommended actions may be based on the context 502, the historical data 508, and the configurable rules 512.

As previously mentioned, the context 502 may generally include a record related to the customer, such as an incident, interaction, or the like, that the agent addresses via a client portal. That is, the context 502 may refer to the record authored by an administrator for which information is collected, such as information for the customer requesting a resolution, the agent, technical information related to a request for the customer, and so forth. By way of example, if the customer requests a resolution for an issue related to a product or service provided by the client, the context 502 may include information related to the product or service, information related prior customer contacts in general or specific to the product or service, information related to the agent's experience level and/or technical background, and so forth. In some instances, the context 502 may include information collected during execution of a first decision tree of a selected recommended action e.g., one or more guided actions for the recommended action).

The context data 503 may include the information collected for the context 502. In some embodiments, the context data 503 may be stored in and retrieved from a database 510. For example, the context data 503 may include information about the case based on the customer attributes 504 (e.g., customer account information). In some embodiments, the context data 503 may include data for similarly situated customers (e.g., same salary range calculated attribute 506). When generating the recommended actions, the data for the similarly situated customers may indicate a probability of the customer performing a particular action (e.g., acting upon offer or service offered by the agent for the presently implemented recommended action). If the information is unknown, the agent may request the information from the customer and/or implement methods of data mining from first and/or third party applications and/or databases to obtain such information. In some embodiments, and as will be discussed herein, the agent may request the information at a decision node upon implementing the decision tree for the best recommended action.

The context attributes 504 may include fields or attributes for one or more factors for which the context data 503 is gathered. The context attributes 504 may be defined by the client (e.g., the business) and the context data 503 for the context attributes 504 may be direct information, such that context data 503 is not used to perform additional calculations or computations. The client may use the context attributes 504 to determine the subset of actions to provide as recommended actions to its agents. Since business interests may change over time, the client may update, remove, and otherwise modify the context attributes 504 accordingly. By way of example, in a bank setting where the client is a bank, the context 502 may be a case generated for a customer of the bank and the context attributes 504 may be related to the customer. For example, the context attributes 504 may include whether the customer has purchased a home, whether the customer has a credit card, salary of the customer, and so forth.

The calculated attributes 506 may include one or more factors that are also defined by the client. However, the calculated attributes 506 may include indirect information, such that the context data 503 is used to subsequently perform calculations or computations to determine the context data 503 to use for the calculated attributes 506. By way of example, the calculated attributes 506 may include a salary range for the customer (e.g., high income, mid-level income, or low income), which may be an indirect computation of the context data 503 of the customer salary. By way of another example, the calculated attribute 506 may include a calculated attribute 506 of a credit ranking or score that is computed based on direct inputs of income and debt for the customer.

In some embodiments, the recommended actions may be generated based on the context attributes 504, the calculated attributes 506, and weights 505 associated with each of the factors of the context attributes 504 and/or the calculated attributes 506. Specifically, the factors may each be associated with weights 505 that are defined by the client. That is, some factors may be associated with heavier weights 505, indicating that the factors have a relatively greater significance with respect to a determination of the recommended actions as being the best recommended actions and/or their ranking, while other factors may be associated with lighter weights 505, indicating that the factors have a relatively lesser significance.

Generating recommended actions may also involve historical data 508. The historical data 508 may include past data related to the customer. The historical data 508 may include data indicating each customer action (e.g., customer financed home loan through the bank) or customer-client interaction (e.g., customer conversation with the agent of the bank) since association with the client, such as since the date that the customer opened an account with the client. In some embodiments, the historical data 508 may also include an indication of actions that the customer acted upon in the past, such as applying for a credit card during a promotional period associated with the credit card application, or refinancing a home loan every five years, and so forth. In this manner, the recommended actions may be specifically tailored to customer preferences. The historical data 508 may also indicate a likelihood that the customer will act upon a particular recommended action. That is, the historical data 508 may facilitate in effectively removing false positives from the generated recommended actions, such as for the best recommended action, by applying a filter or filter type process to recommended actions that the customer may not be likely act upon based on past actions.

Client interest 509 may include the primary interest and/or sub-interests associated with the client and/or client instances. Specifically, the client may be a business (e.g., bank) and have an overall interest while departments of the business may have department based sub-interests. As such, the recommended actions may vary between agents based on the interest for the department based sub-interests. Additionally, the hierarchy and ranking of the ranked recommended actions 514 may be based on the client interest 509. In some embodiments, the historical data 508 and the client interest 509 may also be associated with weights 505, such that one or more pieces of historical data 508 are given a greater weight or a lesser weight than other historical data 508 and one or more client interests 509 are given a greater weight or a lesser weight than other client interests 509.

As shown, configurable rules 512 may use the context 502, which includes the context attributes 504 and the calculated attributes 506, the historical data 508, and the client interest 509, to generate and rank recommended actions 514 (e.g., hierarchy of best recommended actions). The configurable rules 512 may include a set of rules or algorithms to determine a subset of actions as the recommended actions (e.g., best recommended actions) and to rank them as ranked recommended actions 514. In some embodiments, the rules or algorithms may include one or more machine learning algorithms and/or one or more statistical models, such as linear regression, logistic regression, decision trees, support vector machine (SVM), and the like. For example, based on data collected over time, the machine learning algorithms and/or statistical models may generate a subset of recommended actions as most applicable recommended actions (e.g., best recommended actions), and order a number of them in hierarchy (e.g., the ranked recommended actions 514). The number of generated recommended actions may be based on and/or defined by the client. In some instances, the number of recommended actions to provide to the agent may default to three recommended actions 514, in which the top or highest ranked of the three recommend actions is the best recommended action (e.g., next best action) of best recommended actions. Specifically, the machine learning algorithm may learn about the agent, similarly situated agents, the customer, the department, the client interest 509 over time, and/or other business related information, and generate and rank the subset of ranked recommended actions 514 based on a predicted likelihood that the customer will act in accordance with the recommended actions (e.g., apply for the recommended credit card, apply for a new home loan, etc.).

The client may define the configurable 512 rules and subsequently redefine them. That is, the configurable rules 512 may be reconfigurable, such that the parameters of the rules or algorithms may be updated, removed, added, and/or otherwise modified. In some embodiments, the configurable rules 512 may be predefined with rules applicable to a variety of business, such that the client may have an initial starting point before adding client based rules or modifying the predefined rules.

Moreover, the configurable rules 512 may be conditional, such that the configurable rules 512 are based on the one or more factors of the context attributes 504, the one or more factors of the calculated attributes 506, one or more pieces of historical data 508, and/or one or more client interests 509. As such, the conditions may be updated or change, such as in response to changes in business interests. In some embodiments, the configurable rules 512 may also apply weights to each of the context attributes 504, the calculated attributes 506, the historical data 508, and/or the client interest 509. For example, the configurable rules 512 may be configured to apply a relatively heavier consideration (e.g., weight) to the historical data 508 when customer satisfaction is the primary business interest. In some embodiments, the conditions may be based on the particular business field or area associated with the client or the groups or departments for which the recommended actions may be generated. That is, the conditions may be set based on the particular user of the recommended actions (e.g., an agent of a particular department, another agent of a different department, the customer, and so forth). The reconfigurable rules 512 may also be extensible, such that new rules and/or new conditions may be associated with each of the recommended actions.

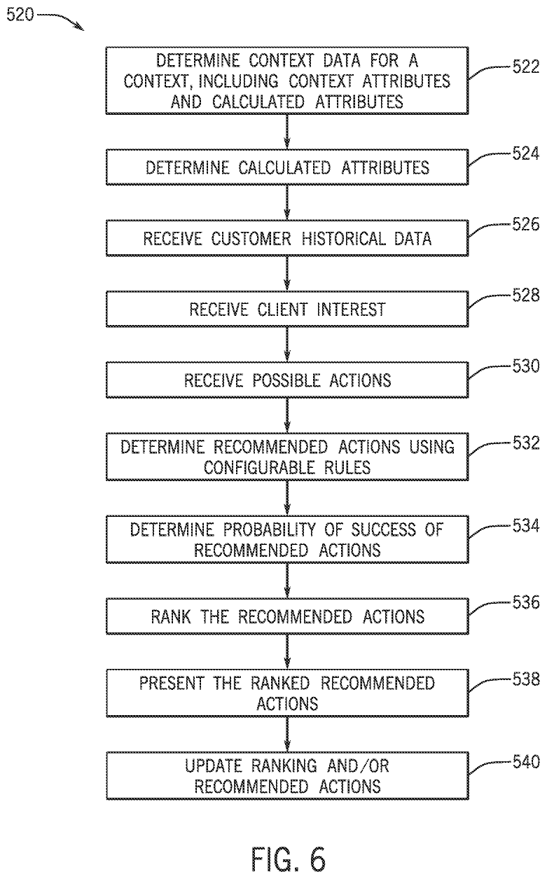

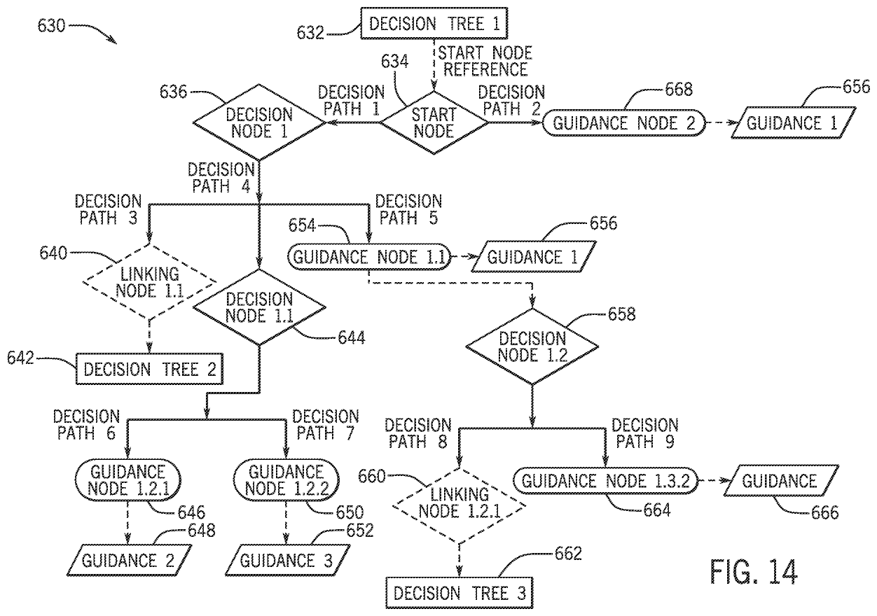

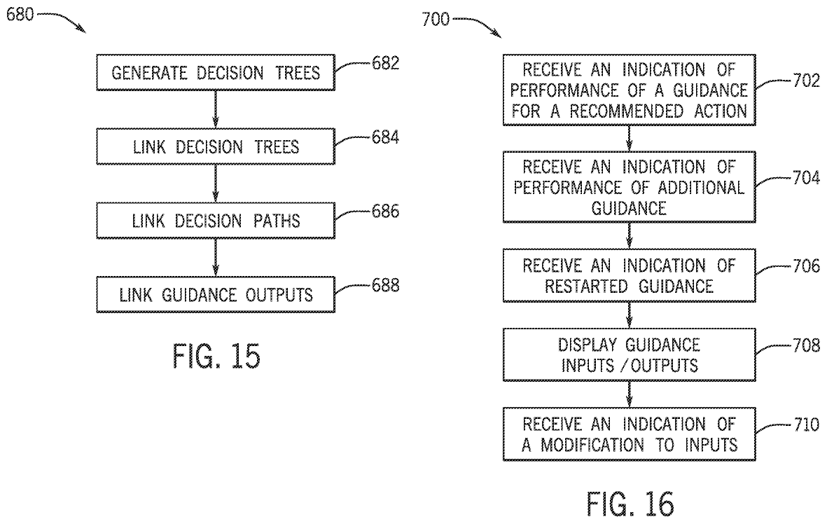

To summarize the process for generating the recommended actions, FIG. 6 depicts a process 520 for providing and updating recommended actions (e.g., best recommended actions). As described herein, the process 520 describes generating the recommended actions, ranking the recommended actions, and updating the recommended actions. While the process 520, and other processes described herein (e.g., process 630 of FIG. 14, process 680 of FIG. 15, and 700 of FIG. 16), are described according to a certain sequence, it should be understood that the present disclosure contemplates that the described steps may be performed in different sequences than the sequence illustrated or in parallel to one another, and certain described steps may be skipped or not performed altogether. In some embodiments, the process 520 may be implemented at least in part by executing instructions stored in a tangible, non-transitory, computer-readable medium, such as the memory 86, using processing circuitry, such as the processor 82. Additionally or alternatively, the process 520 may be implemented at least in part by circuit connections and/or control logic implemented in a cloud computing system 80. In some implementations, the process 520 may be implemented by the server 26 of FIG. 2, which may be associated with an underlying hardware implementation that includes a memory 86 and processor 82.

To generate the recommended actions, the process 520 may include the processor 82 determining (block 522) context data 503 for a context 502, as described with respect to FIG. 5. As previously discussed, the context 502 may include the data for which recommended actions are being generated. For example, the data may include information related to a customer request when the recommended actions are generated for a resolution to the customer request. The context 502 may include context attributes 504 and calculated attributes 506, as discussed with respect to FIG. 5. Thus, the processor 82 may determine and retrieve the relevant context data 503 from the database 510.

The context attributes 504 and calculated attributes 506 may include fields for factors for which the context data 503 is gathered. Briefly, and as discussed with respect to FIG. 5, the processor 82 may use the context data 503 directly for the context attributes 504 (e.g., salary of the customer) while using the context data 503 indirectly for the calculated attributes 506 (e.g., salary range of the customer based on the salary). That is, the processor 82 may determine (block 524) the calculated attributes 506 by performing one or more computations with the context data 503 to determine the data for the calculated attributes 506.

The processor 82 may also receive (block 526) the historical data 508 for the context. That is, based on the details of the context 502, such as the entities involved (e.g., the customer and the client), the processor 82 may receive the historical data 508 pertaining to the context 502. By way of example, to resolve a customer request, the historical data 508 may include past data related to the customer and/or past data for similarly situated customer (e.g., same salary range for the customer), especially when the customer is a new customer and may have little or no past data.

The processor 82 may receive the client interest 509 (block 528), which may include the present business interest for the particular client. The client interest 509 may vary between groups of the client, such as the different departments within the business. Thus, in some embodiments, the client interest 509 may be specific to the department associated with the agent resolving the request. In additional or alternative embodiments, the client interest 509 may include multiple interests (e.g., of the overall or general client and of the specific department of the client) and each of the interests may be weighted when generating the recommended actions. A higher interest may be associated with a relatively heavier weight and a lower interest may be associated with a relatively lighter weight.

The processor 82 may receive possible actions (block 530). The possible actions may include every action possible for the particular agent, the department associated with the agent, and/or for the particular context 502. As such, in some embodiments, the processor 82 may also identify the agent resolving the customer request, for example, based on an agent identifier (ID) or agent credentials when accessing the client portal.

Afterwards, the processor 82 may determine (block 532) the recommended actions using the configurable rules 512, as discussed with respect to FIG. 5. Specifically, the processor 82 may apply statistical models and/or machine learning algorithms based on the configurable rules 512 to received data for the context 502 (e.g., the context attributes 504 and the calculated attributes 506), the historical data 508, and/or the client interest 509, to determine the most applicable or relevant recommended actions for the agent to implement. That is, the processor 82 may filter the possible actions using this data to determine the best recommended actions for the context 502 (e.g., above a predetermined threshold level of relevance).

The processor 82 may also determine (block 534) a probability of success of the recommended actions. That is, based on the historical data 508, the processor 82 may determine which of the relevant recommended actions the customer is likely to positively act upon (e.g., in accordance with client interest 509). In some embodiments, the processor 82 may use the probability of success for possible actions when determining the relevant recommended actions. As previously mentioned, the configurable rules 512 may include limiting the recommended actions to a particular number. Thus, the processor 82 may determine the most applicable and/or the most likely to be successful recommended actions to provide to the agent as the best recommended actions (e.g., subset of recommended actions).

Based on the probability of success and the client interest 509, the processor 82 may rank (block 536) the most relevant recommended actions. That is the processor 82 may create a hierarchy of the best recommended actions in the subset. The most recommended action in the subset is the best recommended action or the next best action. Generating multiple recommended actions may enable the agent to view the top recommended actions in the hierarchy and/or select one of the best recommended actions. In some instances, the agent may select the second or third most recommended action, for example, based on additional information not provided to or accessible by the processor 82.

The processor 82 may present (block 538) the ranked recommended actions 514. In particular, the processor 82 may provide the ranked recommended actions 514 to the agent on a graphical user interface (GUI) of a display (e.g., associated with the client portal). The processor 82 may update (block 540) the ranking and/or the recommended actions. Specifically, the processor 82 may perform the updates periodically or upon a triggering event, such as upon receiving new data for the context 502.

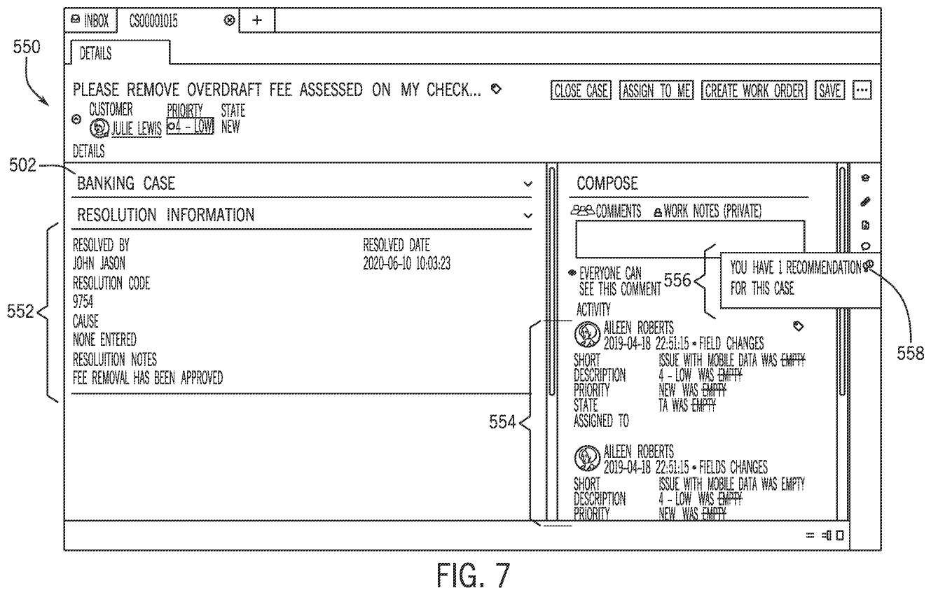

To illustrate, FIG. 7 is a block diagram of a GUI 550 on a display, displaying an indication of a new recommended action based on customer activity. In the depicted embodiment, a customer requests a resolution for fees assessed on a check, and as such, the context 502 may include a banking case, a penalty or fees case, a checking case, and so forth. A resolution information 552 associated with a currently implemented best recommended action may include information related to the case, such as but not imitated to, a name of the agent resolving the case (e.g., John Jason), a time/date of the resolution (e.g., 2020-06-20; 20:03:23), a resolution code for the particular resolution (e.g., 9754), and resolution notes (e.g., fee removal has been approved).

While the agent is implementing the selected recommended action, such as by performing a guidance at decision nodes of a corresponding decision tree for the recommended action, the customer may interact with the client. In the depicted GUI 550, a customer activity 554 shows one or more new activities that may occur after the agent begins implementing the recommended action (e.g., implementing a first guidance action). In the depicted customer activity 554, the customer generated an additional request related to an issue with mobile data. Thus, while the agent is implementing the recommended action, a recommendation notification 556 associated with a recommendation icon 558 may appear on the GUI 550. In some embodiments, the recommendation notification 556 may appear on a side panel near the customer activity 554 upon the occurrence of the new user activity. The new activity may cause the currently implemented recommended action to no longer be applicable, relevant, and/or be in the subset of best recommended actions. That is, the new customer activity may dynamically trigger one or more new recommended actions.

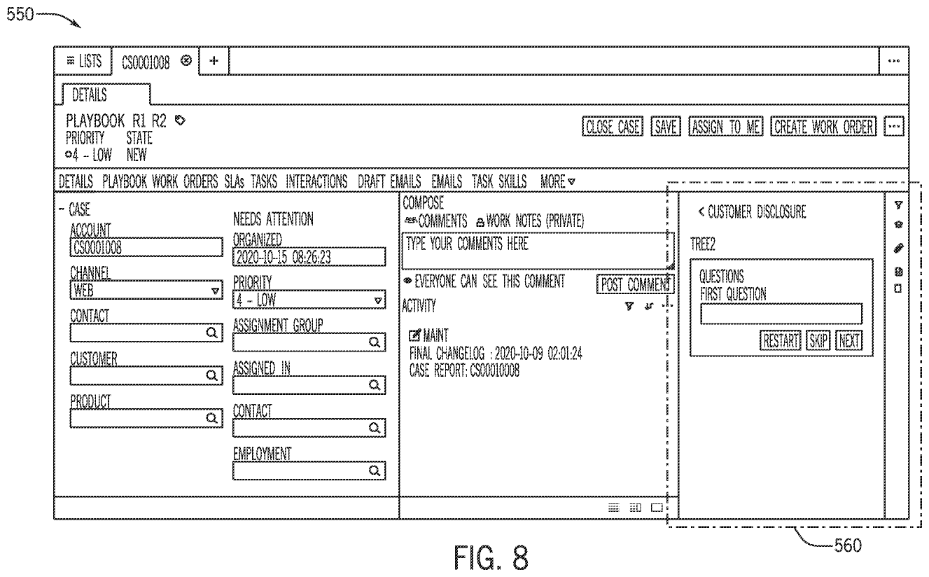

Thus, the agent may pause or stop the presently implemented recommended action and switch to the new recommended action via the recommendation icon 558 (e.g., by clicking on the icon). FIG. 8 is a block diagram of the GUI 550 displaying steps of a guided decision tree corresponding to a presently executed recommended action for the banking case. Guided decisions 560, as indicated by the dashed line box, may show the presently implemented decision tree, completed decision trees, and/or new decision trees. For the currently implemented decision tree, the guided decisions 560 may also show the questions corresponding to decision node. The agent may input data into the question fields to move through the decision tree, for example, to a subsequent decision node or a guidance node in the decision tree. In some instances, the inputs may trigger the related recommended actions (i.e., actions from a related or separate decision tree).

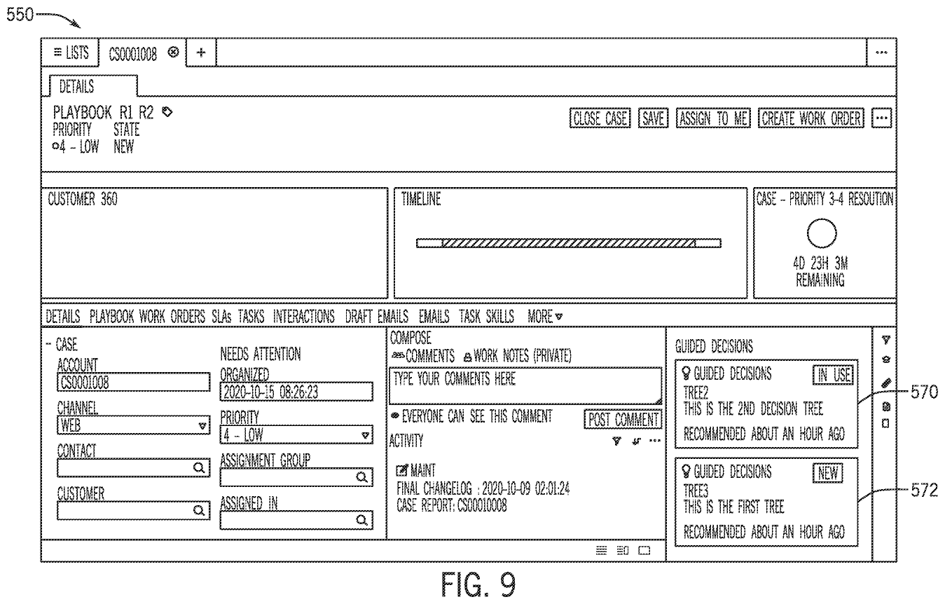

FIG. 9 is a block diagram of the GUI 550 displaying the presently executed recommended action, as well as a new recommended action, as discussed with respect to FIG. 7. Here, the agent implements a first recommended action 570 corresponding to decision tree of “tree 2,” indicated to be “in use.” However, based on the customer activity 554 triggering a new best recommended actions, the guided decisions 560 may provide a second recommended action 572 corresponding to a decision tree of “tree 1,” indicated to be “new.” The new decision tree may correspond to the highest ranked best recommended action. Although the depicted embodiment shows one new recommended action, which may be based on particular client information associated with the configurable rules 512, the guided decisions 560 may instead include multiple best recommended actions (e.g., two, three, etc.).

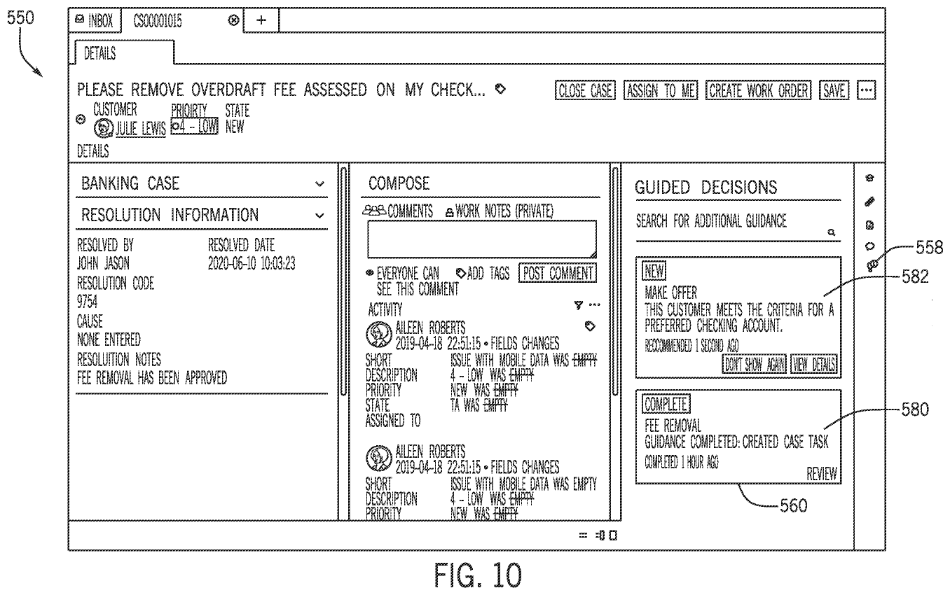

FIG. 10 is a block diagram of the GUI 550 displaying examples of the recommended actions and corresponding decision trees in the guided decisions 560. The agent may complete a recommended action (as shown) or may be implementing the recommended action. However, after the agent clicks on the recommendation icon 558 (e.g., in response to new customer activity 554), the guided decisions 560 may update to reflect the completed recommended action 580, as well as the new recommended action 582. In the depicted example, the processor 82 may determine that the customer meets the criteria for a preferred checking account and recommend providing a corresponding recommendation as the new recommended action 582 to the agent.

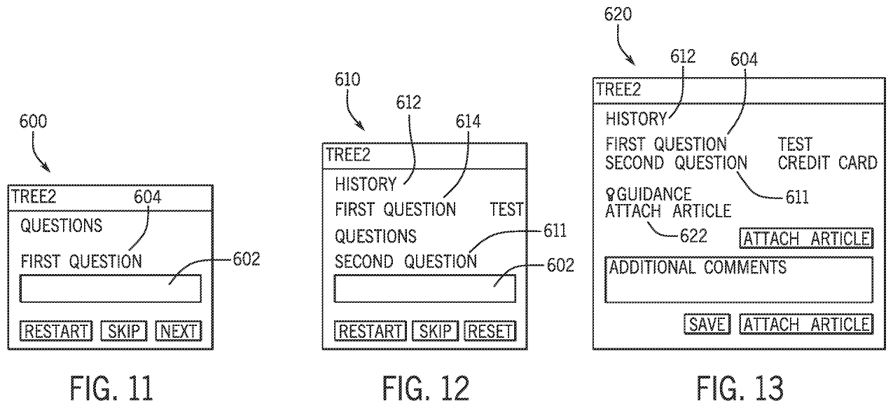

To illustrate the agent implementing a selected recommended action, FIG. 11 is a block diagram 600 of a first question at a first node of a decision tree for a presently executed recommended action. In some embodiments, the processor 82 may request information as needed while the agent implements the recommended action. That is, the processor 82 may receive this information from other sources, such as the database 510 and/or from the customer. Alternatively, the processor 82 may skip the decision node and/or prefill the information if the information is known. As shown, the agent may enter an input in an editable field 602 for a first question 604, which corresponds to the first node in the decision tree. In response to entering an input in the editable field 602, the agent may be guided to a second node in the decision tree of the presently executed recommended action.

FIG. 12 is a block diagram 610 of a second question at a second node of the decision tree based on the outcome of the first question 604. That is, based on the input entered for the first question 604, the decision tree may guide the agent to a specific second node of the decision tree corresponding to the second question 611. Here, the agent may also input data (e.g., text) in the editable field 602 to answer the second question 611. In some instances, the decision tree may guide the agent to the second node of the decision tree without respect to the outcome of the first node, for example, when the decision tree includes gathering information through multiple nodes (e.g., unconditional nodes). As shown, the GUI 550 may display a log or decision history 612 of the questions and/or corresponding inputs (e.g., answer) for guidance for the presently executed recommended action and/or related recommended actions.

FIG. 13 is a block diagram 620 of a completed execution of the recommended action. In the depicted recommended action, the decision tree includes two nodes corresponding to two questions, the first question 604 and the second question 611. Upon completion of the second question 611, the guidance for the recommended action is complete and the agent is prompted with a resolution 622 (e.g., guidance). Based on the answers to the decision nodes, the processor 82 may provide the resolution 622 of attaching an article related to the case. The article may include a step-by-step customer guide to resolve the issue. If the answer to either of the decision nodes is different, the processor 82 may output a different resolution 622, such as to call customer support, mail product back to client (i.e., return the product), create a work order to send a support agent to the address associated with the customer to resolve the request, and so forth. In some embodiments, and as previously discussed, the outcome or output (e.g., result or answers) at the decision nodes and/or at the end of the decision tree may trigger or initialize related decision trees (e.g., nested decision trees, separate decision trees, and so forth). Moreover, the related recommended actions with the corresponding related decision trees may be based on the next best action framework, such that the processor 82 applies the process 520 discussed with respect to FIG. 6 to determine the best related recommended actions (e.g., subset of top related recommended actions). For example, the processor 82 may process the answers to the questions at the decision nodes as additional context data 502, resulting in different recommended actions. Moreover, and as discussed herein, the decision trees for the recommended actions may be linked to one or more decision trees. Thus, the processor 82 may limit the related recommended actions to the linked decision trees.

To illustrate linked decision trees that are interlinked and provide output information from a decision node of a decision tree to a linked decision node of a linked decision tree, FIG. 14 is a flow diagram illustrating a process 630 for linking decision trees corresponding to recommended actions. As will be discussed herein, the processor 82 may provide a guidance through a decision tree for a recommended action and/or a related linked recommended decision tree based on outputs at decision nodes or the decision paths taken by an agent. As shown, the process 630 may include the processor 82 determining (block 632) a first decision tree (decision tree 1) for a selected recommended action, for example, based on the previously discussed best recommended actions. The first decision tree may reference, as shown by the dashed line arrow (e.g., reference path), a starting node (start node) as a reference node. The decision paths may lead the agent to a decision node or a guidance node. The processor 82 may request a decision between one or more options and associated paths at the decision node, and may provide a guidance action at a guidance node.

In the depicted decision tree, the processor 82 may determine (decision node 634) whether the agent takes a first decision path (e.g., decision path 1) or a second decision path (e.g., decision path 2), as indicated by the solid line arrows (e.g., decision path). If the agent takes the first decision path, the processor 82 may guide the agent to a first decision node (decision node 1) and the processor 82 may determine (decision block 636) whether to the agent takes a third decision path (decision path 3), a fourth decision path (e.g., decision path 4), or a fifth decision path (decision path 5). If the agent takes the third decision path, the processor 82 may guide the agent to a first linked node (linked node 1.1), as indicated by the dashed line shape. At this first linked node the processor 82 may determine whether (decision node 640) the agent implements the actions for the first linked node, such as by accepting the guidance for the first linked node and/or inputting information requested for the linked node.

If the agent does implement the actions for first linked node, the processor 82 may provide (block 642) the agent with a second, separate decision tree (decision tree 2) with respective decision nodes, guidance nodes, and guidance actions. The second decision tree may be an existing decision tree and thus, the first linking node may call the second decision tree. On the other hand, if the agent takes the fourth decision path, the processor 82 may guide the agent to a second decision node (decision node 1.2) and the processor 82 may determine (decision node 644) whether the agent takes a sixth decision path (decision path 6) or a seventh decision path (decision path 7).

If the agent takes the sixth decision path, the processor 82 may guide (guidance node 646) the agent to a first guidance node (guidance node 1.2.1) at which the processor 82 may reference and provide a second guidance (data block 648) (guidance 2). On the other hand, if the agent takes the seventh path, the processor 82 may guide (guidance node 650) the agent to a second guidance node (guidance node 1.22) at which the processor 82 may reference and provide a third guidance (data block 652) (guidance 3).

However, if the agent takes the fifth decision path, the processor 82 may guide the agent to a third guidance node (guidance node 654) (guidance node 1.3), at which the processor 82 may reference and provide a first guidance (data block 656) (guidance 1). The processor 82 may also reference and guide the agent to a third decision node (decision node 658) (decision node 1.3). The processor 82 may perform similar guidance processes for the second linking node 660 (linking node 1.3.1) that results in linking a third decision tree 662 (decision tree 3), a fourth guidance node 664 (guidance node 1.3.2) that references another guidance (data block 666), and a fifth guidance node 668 (guidance node 2) that references and provides the first guidance (guidance 1) (data block 656). That is, executing a recommended action may link and call one or more discrete decision trees based on the decision at a decision node of the presently executed decision tree for the recommended action. In some instances, different decision paths may result in the same guidance (e.g., guidance 1).

To illustrate the authoring process for linking or nesting the decision trees as related recommended actions, FIG. 15 is process flow diagram of an authoring process 680 for creating or authoring of guided decision trees corresponding to the recommended actions. The authoring process 680 may include the processor 82 generating (block 682) decision trees, which may be discrete separate trees rather than one large tree, each having separate nodes corresponding to specific questions and/or guidance actions (e.g., automated or manual actions to implement), separate guidance actions or resolutions, and so forth. In particular, an administrator (e.g., an author of the decision tree) may provide an indication that the design structures for the decision trees is completed, causing the processor to generate the decision trees. The administrator may create decision trees with decision nodes for each of the possible recommended actions. In particular, the administrator may associate one or more questions or guidance actions at each of the decision nodes to ultimately guide an agent to the guidance resolution for the recommended action.

After the decision trees are generated, the processor 82 may link (block 684) the decision trees for the recommended actions. That is, the decision trees that are related within a resolution process (e.g., for a larger issue or a common issue), business workflow, particular product or service, or otherwise related, may be linked. Rather than extending paths down one decision tree, the administrator may create a link between separate decision trees corresponding to guidance for different recommended actions. Such use of linked, separate decision trees may allow a given tree to be linked or used in many different guidance processes, in contrast to the generation of a larger, single integrated decision tree.

Linking the decision trees may facilitate generating the related recommended actions in response to a particular outcome or result at a decision node or upon completion a presently executed decision tree for a selected recommended action. That is, the nodes of the decision trees may be sequentially linked, such that the agent is guided to a different or new discrete tree (rather than downstream within the same decision tree) in response to an outcome at a decision node or guidance node of the presently executed decision tree. In some embodiments, the linkage may be associated with one or more conditions at the decision or guidance node, such that a particular string of characters (e.g., letters, numbers, and/or symbols), such as a status code, may cause the agent be guided to the linked decision tree or a node of the linked decision.

The authoring process 680 may also include the processor 82 linking (block 686) decision paths. That is, the administrator may create and connect decision paths between decision nodes for each of the decision trees and between the decision trees, such that the agent is guided to or switch to different decision nodes and/or decision trees based on the selected decision path, as discussed with respect to FIG. 14.

After linking the decision paths, the processor 82 may link (block 688) guidance outputs, such as for outcomes or results at a decision node, a guidance node, and/or at the end of a decision tree (e.g., corresponding to an agent completing the guidance for the presently executed decision tree). The outputs may include simple and/or complex outputs. The simple outputs may include “yes,” “no,” “pass,” “fail,” and so forth, one word-type outputs, while the complex outputs may include specific information related to the guidance or input at the guidance. By way of example, the specific information related to the guidance may include feedback from the guidance action (e.g., the status code) or feedback to be performed for other guidance for related decision trees (e.g., how did the test fail, and if it failed because of reason x, go to decision tree x, otherwise go to decision tree y). Thus, by linking the outputs from a guidance at a decision node and/or at the end of the decision tree, the processor 82 may facilitate utilizing information gathered from the presently implemented decision tree to the subsequent linked decision tree. In this manner, the agent proceeding through the guidance for the decision tree may avoid reentering the same or approximately the same information for the linked decision tree and/or skip one or more decision nodes with the linked decision tree.

FIG. 16 is a guidance process 700 to guide an agent for a selected recommended action (e.g., one of the best recommended actions generated via the next best action framework discussed herein). The guidance process 700 may include the processor 82 (block 702) receiving an indication of an agent performing a guidance for a selected recommended action. That is, processor 82 may have received an indication of the selected recommended action and provided the corresponding decision tree to the agent. The processor 82 may subsequently receive an indication of the agent performing the guidance, such as by an indication of inputs entered by the agent at questions associated with decision nodes and/or at guidance actions for the guidance nodes and/or the decision tree.

In response to performance of the guidance, answers received during the guidance, information received from the customer, or an indication of the decision paths otherwise taken by the agent, the processor 82 may provide additional guidance. That is, various factors (e.g., answers received form the agent during the guidance, answers or information received from the customer, etc.) may trigger a request for the agent to execute a recommended action corresponding to a nested or linked decision tree, which corresponds to an additional guidance or a different guidance. As such, the processor 82 may receive (block 704) an indication of performance of the additional guidance. The additional guidance may include guidance for a related or new recommended action. In some embodiments, the processor 82 may receive (block 706) an indication of a restarted guidance. Specifically, the agent may restart the guidance for the presently executed decision tree or previously implemented guidance for other decision trees, at any point of guidance to resolve the task (e.g., the customer request). As previously mentioned, the decision trees are separate and discrete trees, and as such, the agent may restart guidance for the discrete decision trees. By way of example, the agent my restart the guidance in response to an indication that the information input previously entered during the guidance may be incorrect.

The guidance process 700 may also include the processor 82 displaying (block 708) the guidance inputs and/or outputs. That is the processor 82 may display the previously entered information (e.g., at the questions or guidance actions) and/or the outputs from previously executed decision trees. In this manner, the processor 82 may facilitate a holistic view of the guidance thus far for the agent. In some embodiments, the agent may update, remove, add, or otherwise modify previously entered inputs during the guidance. For example, the agent may change the input for an answer to a question at a decision node. As such, the processor 82 (block 710) may receive an indication of the modification to the input. The agent may modify inputs at any time during the guidance, prior to the final guidance for the presently executed decision tree. In some embodiments, the change may cause the processor 82 to provide different or additional guidance to the agent.

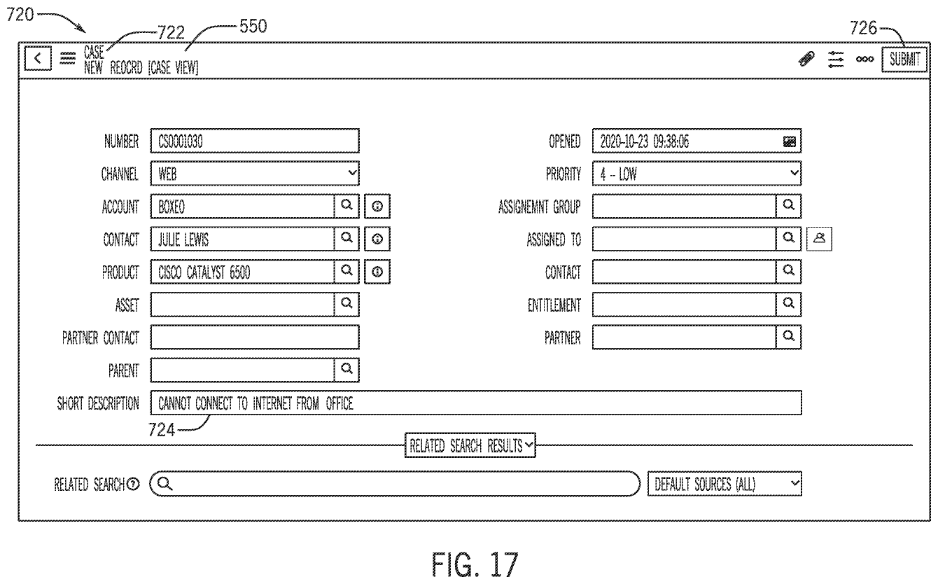

FIG. 17 is a block diagram of a case generation 720 in the GUI 550 on the display for the agent. The agent may receive a request from a customer to resolve a request. Based on information from the customer, the agent may generate a new case 722. The processor 82 may automatically generate information for one or more fields related to the case 722 and/or the agent may enter the information. By way of example, the fields may include a case number, a communication channel associated with the request, an account type for the customer, a contact information for cases 722 related to the account type, the product associated with the request, a time/date that the case 722 ticket was generated, a priority level associated with the request (e.g., based on the account type), and so forth.

One of the fields may include a short description 724 describing the request. Here, the agent may enters the description indicating that the problem (e.g., the customer is unable to connect to the internet from an office space). After entering information for the fields, the agent may submit the case via a submit button 726. The processor 82 may then provide best recommended actions to resolve the case 722, as described with respect to FIG. 5 and FIG. 6.

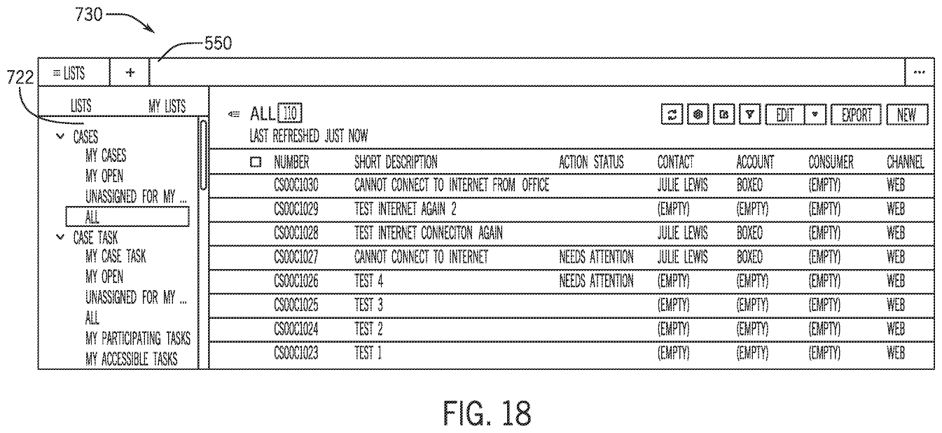

FIG. 18 is a view of pending and/or completed cases 730 on the GUI 550. The cases 722 may be sorted by the agent (e.g., my cases), pending cases to be resolved by the agent (e.g., my open), cases to be assigned for the agent or another agent within the department, or each of the pending and/or completed cases 722 without filtering (e.g., by agent). The view of the pending and/or completed cases 730 may also include the description for cases, action status, contact for the account type, and so forth.

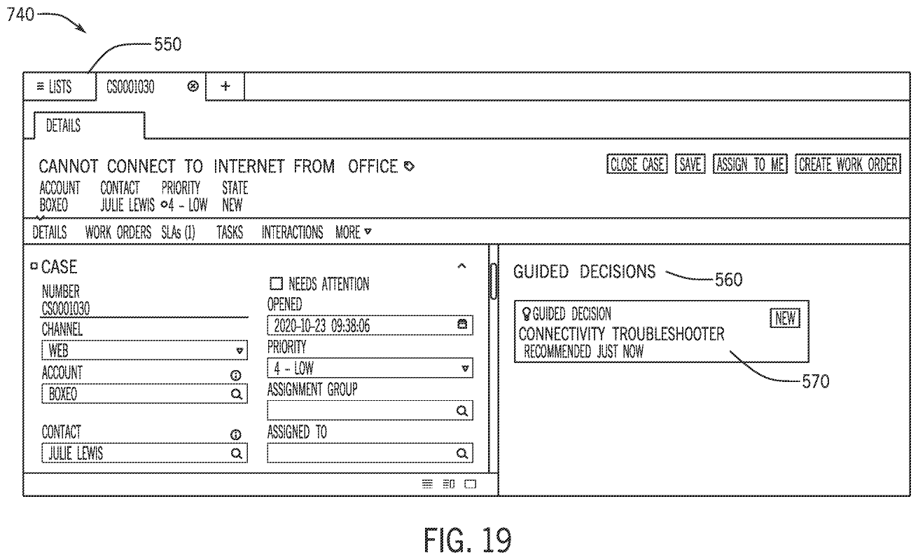

Upon the agent selecting one of the cases, the processor 82 may provide the corresponding guidance for a selected recommended action. In some embodiments, the processor 82 may provide guidance for a single best recommended action. To illustrate, FIG. 19 shows is a block diagram of guidance details 740 for a selected case 722 in the GUI 550. The guidance details 740 may include information for the case 722 and the guided decisions 560. The guided decisions 560 may include the best recommended actions. Although the depicted embodiment shows the guided decisions 560 including the single best recommended action, the first recommend action 570, the system and methods described herein may include one or more best recommended actions and/or ranked recommended actions 514, as previously mentioned.

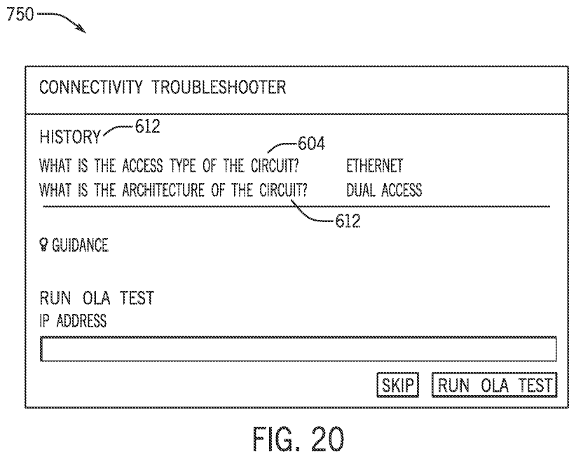

FIG. 20 is a block diagram of a guidance execution 750 for the first recommended action 570 of FIG. 19 for the selected case. As shown, the guidance execution 750 may include the history 612 of previous questions and answers for a first question 604 and a second question 611 (e.g., at decision nodes) in the presently executed decision tree for the first recommended action 570. By way of example, based on the history 612, the processor 82 may guide the agent to the depicted guidance of running an OLA test. The processor 82 may request input of information as a guidance action, such as a request for an IP address for the device unable to connect to the network at the office. Additionally or alternatively to the depicted embodiment, the processor 82 may request the guidance action of a different test, such as a pinging test, if the agent provides a different answer at the decision nodes. In some embodiments, the output (e.g., result) at the guidance action of the test result may result in an additional guidance for the agent to execute.

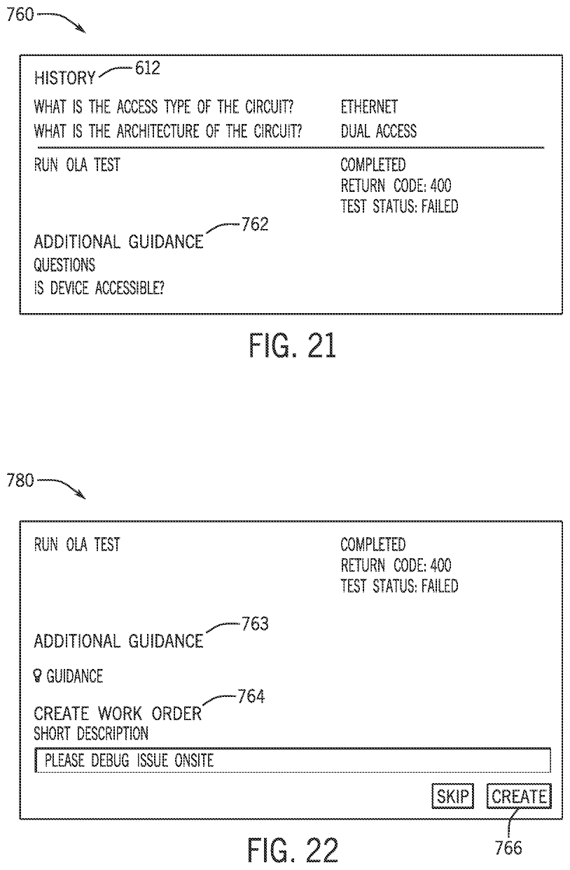

FIG. 21 is a block diagram illustrating an additional guidance execution 760 for the additional guidance 762 corresponding to a linked decision tree (e.g., for a best related recommended action). The processor 82 may generate the particular additional guidance 762 for the agent based on information from the guidance for the presently executed first recommended action 570. Additionally, the processor 82 may use the inputs and/or outputs from the presently implemented guidance to provide the additional guidance 762. In the depicted embodiment, output from the guidance for the first recommended action 570 includes a return code (e.g., return code: 400) and a test status (e.g., failed). The history 612 may indicate a log of questions and answers for the presently and previously executed decision trees. As shown, the additional guidance 762 may request input (e.g., at a decision node of the linked decision tree). Here, the processor 82 requests for input information related to the device accessibility. By using the output information from the previous guidance, the processor 82 may avoid requesting the same information (e.g., run OLA test) for the additional guidance 762. In response to the agent providing an input indicating the device accessibility, the processor 82 may provide another or further additional guidance for a related best recommended action or no additional guidance.

FIG. 22 is a block diagram illustrating a second additional guidance execution 780 for a second additional guidance 763 (e.g., a further additional guidance) corresponding to another linked decision tree (e.g., for a related best recommended action to the previously executed best recommended action). Based on the outputs from the previous guidance, the processor 82 may generate the second additional guidance 763. For example, based on the output indicating that the device is accessible, the processor 82 may guide the agent to a subsequent second additional guidance 763, such as creating a work order 764 to debug the issue onsite. However, if the output indicates that the device is not accessible, the processor 82 may instead provide an alternate guidance, such as performing a remote reset of the device and/or attaching an article for the customer to perform additional tests. The processor 82 may receive an indication that the agent submits the request for the work order via a create button 766.

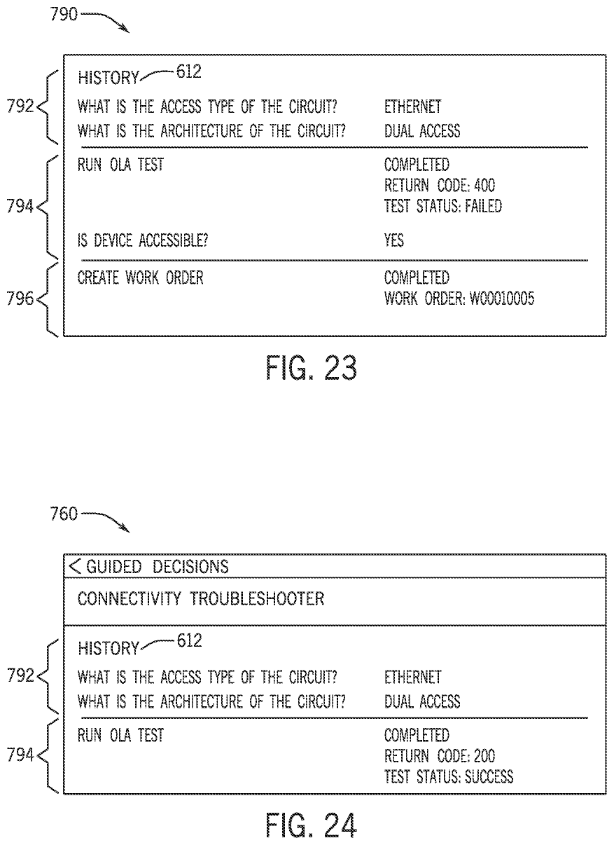

FIG. 23 is a block diagram of a completed guidance 790 for nested decision trees for the related recommended actions to resolve the customer request. As shown, the completed guidance after creating the work order 764 may show a history 612 of each guidance performed until completion. In some embodiments, such as the depicted embodiment, the history 612 may be segmented by guidance and corresponding decision trees, such as a first guidance 792, a second guidance 794 (e.g., additional guidance 762), and a third guidance 796 (e.g., second additional guidance 763). The completed guidance 790 may provide the agent a view of the questions and answers, tests and results, customer information and answers, and so forth, for each guidance until receiving the resolution (e.g., work order 764).

FIG. 24 is a block diagram of the additional guidance execution 760 (e.g., of FIG. 20) for different or new input. By way of example, the customer may provide new or different input initially or during execution of the decision tree, and as such, the recommended action may change. By way of example, the customer may provide a different IP address for the device. As shown, the history 612 of the first guidance 792 may be the same. However, for the second guidance 794 corresponding to the additional guidance 762, the OLA test results may indicate a successful execution (e.g., rather than the failed execution of FIG. 20). That is, the output of the second guidance 794 includes a successful test status and a return code indicating the successful test. Since the test is successful, the processor 82 may not generate the third guidance 796. Instead, the processor 82 may determine that the guidance has been completed and that the case is resolved. Thus, based on the specifics of the outcome of a presently executed guidance, the processor 82 may end a guidance or link one or more of the particular nested decision trees to continue guidance.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising one or more client instances of a client hosted by a platform, the one or more client instances comprising:
an agent portal, configured to:
receive a request from a customer related to a customer issue;
determine a context for the customer issue based on one or more attributes;
determine a subset of actions as recommended actions based on one or more factors to resolve the customer issue, wherein the one or more factors comprise the context, historical data associated with the customer, a client interest associated with the client, or any combination thereof;
rank the recommended actions as ranked recommended actions;
display the ranked recommended actions for selection in the agent portal; and
provide a guidance corresponding to a selected recommended action of the ranked recommended actions, wherein the guidance comprises one or more actions.

2. The system of claim 1, wherein the attributes are associated with direct information, indirect information calculated based on the direct information, or a combination thereof.

3. The system of claim 1, wherein the one or more factors comprise an interest area of the client associated with the one or more client instances, a likelihood of the customer acting in accordance with the interest area, or a combination thereof.

4. The system of claim 1, wherein an output resulting from execution of the guidance causes a trigger for the agent portal to perform an additional guidance corresponding to a related recommended action.

5. The system of claim 1, wherein determining the recommended actions, the ranking of the recommended actions, or a combination thereof, is based on machine learning.

6. The system of claim 1, wherein determining the one or more attributes comprises direct information, calculated information, or a combination thereof.

7. The system of claim 6, wherein the one or more attributes are associated with one or more weights.

8. The system of claim 1, wherein the agent portal is configured to:
provide an additional guidance corresponding to a related recommended action relating to the selected recommended action in response to a particular output from the one or more actions.

9. The system of claim 8, wherein the guidance for the selected recommended action and the additional recommended action correspond to linked decision trees.

10. The system of claim 1, wherein the agent portal is configured to:
update the subset of actions as the recommended actions in response to activity associated with the customer; and
in response to the update, display an indication of one or more new recommended actions.

11. A method, comprising:
determining, via a processor, a context for a case resolved by a client, wherein the context is associated with a customer request for a customer based at least in part on a context attribute, a calculated attribute, or a combination thereof;
receiving, via the processor, historical data associated with the customer;
receiving, via the processor, a client interest associated with the client;
receiving, via the processor, one or more possible actions to provide as recommended actions;
determining, via the processor, one or more recommended actions based at least in part on configurable rules, the context, the historical data, the client interest, or any combination thereof;
determining, via the processor, a probability of the customer acting upon the one or more recommended actions;
updating, via the processor, the one or more recommended actions based on the probability; and
determining, via the processor, a hierarchy of the one or more recommended actions to provide to an agent resolving the customer request.

12. The method of claim 11, wherein the configurable rules comprise predetermined rules configurable by the client.

13. The method of claim 11, wherein the configurable rules are extensible by enabling the client to add additional rules for determining the one or more recommended actions.

14. The method of claim 11, wherein each of the one or more recommended actions correspond to a guidance comprising respective one or more decision trees, and wherein the respective one or more decision trees are linked for resolving the customer request.

15. The method of claim 14, wherein a first output at a decision node of a first decision tree of the respective one or more decision trees causes the guidance to switch to a second decision tree of the respective one or more decision trees, and wherein a second output different than the first output at the decision node causes the guidance to switch to a third decision tree of the respective one or more decision trees.

16. The method of claim 15, wherein the first output and the second output comprise a status code for an executed test performed during the guidance.

17. A non-transitory computer-readable storage medium storing executable instructions that, when executed by one or more processors, cause operations to be performed comprising:
generate decision trees corresponding to recommended actions;
link the decision trees based at least in part on a common process for resolving a task;
link decision paths between the decision trees; and
link outputs from decision nodes, guidance nodes, or a combination thereof, of the decision trees.

18. The non-transitory computer-readable storage medium of claim 17, wherein a first output at a decision node of a first decision tree of the decision trees causes an agent implementing a guidance through the first decision tree to switch to a second decision tree of the decision trees, and wherein a second output different than the first output at the decision node causes the guidance to switch to a third decision tree of the decision trees.

19. The non-transitory computer-readable storage medium of claim 17, wherein the decision trees are linked sequentially.

20. The non-transitory computer-readable storage medium of claim 17, wherein the decision trees are separate and discrete trees.
